(19) United States
(12) Patent Application Publication
(10) Pub. No.: US 2008/0143811 A1
(43) Pub. Date: Jun. 19, 2008

(54) Laser-marking machine with multiple scanheads

(75) Inventors: Michelle Chang, Hsi Chih City (TW); Hungfei Kuo, Hsi Chih City (TW)

Correspondence Address: TROXELL LAW OFFICE PLLC, SUITE 1404, 5205 LEESBURG PIKE, FALLS CHURCH, VA, 22041, US

(73) Assignee: Great Computer Corporation

(21) Appl. No.: 11/640,263

(22) Filed: Dec. 18, 2006

(51) Int. Cl. B41J 2/435

(52) U.S. Cl. 347/241

(57) ABSTRACT

A laser-marking machine comprising a main body, a beam splitter, a plurality of transmitting lines and a plurality of scanheads, wherein the main body has a laser head for producing laser light, the beam splitter is connected with the laser head on the main body, thereby laser light can be split by the beam splitter, one end of each of the transmitting lines is connected to the beam splitter, while the other end of each of the transmitting lines is connected to a corresponding one of the scanheads, thereby the laser light split by the beam splitter can be transmitted to each scanhead through each corresponding one of the transmitting lines.

### BACKGROUND OF THE INVENTION

1. Field of the Invention

The present invention relates to a laser-marking machine with multiple scanheads, especially to a laser-marking machine in which laser light can be output via multiple scanheads by using a beam splitter disposed on a laser head.

2. Description of the Prior Art

Marking on traditional industrial products is made by corrosion, photoelectric processing, mechanical carving, die punching etc. They possess inferior preciseness, and the article obtained are subjected to deformation and with low quality, while the speed of processing is slow. Further, the dies are subjected to damage and need frequently changing. If large mount of products is processed, or their serial numbers or specifications is numerous, the dies for the marking also need frequent changing, thus increasing cost.

At the initial stage of the years of 1980-1990, a new technique of application in laser marking uprose in the world. The technique is an accomplishment from modem high technology of laser and computer technique. When articles of plastic, rubber or mechanical parts, or of electronic devices, instruments, tools etc. are to have their surfaces marking or engraving by composed letters, patterns etc., comparing with conventional mechanical carving, chemical corrosion, silk-net printing, ink printing etc., the laser marking technique possess the outstanding features of wide range of application, high preciseness and accuracy of engraving, capability of being controlled with a computer, non-limitation of life of the marking, and firmness as well as permanence of engravings made on the work pieces by laser.

Laser-marking machine available at the present day, a laser source generated by the machine is effectively sent to a scanhead on the machine for the engraving. However, for the PCB (Printed Circuit Board) industry nowadays, designing and use of a laser-marking machine has had very large limitation. Designing by laser-marking machine faces to the nonstop upgrading in the distances between every two production lines, and faces to miniaturization, to modularization and the requirement of increasing the efficiency of the entire production line of the PCB industry giving directions for this designing.

### SUMMARY OF THE INVENTION

The primary object of the present invention is to provide a laser-marking machine with multiple scanheads for which a conception of one-for-multiplicity is adopted to make the laser-marking machine able to afford use of multiple production lines.

To achieve the above object, a laser-marking machine according to the present invention comprises a main body, a beam splitter, a plurality of transmitting lines and a plurality of scanheads; wherein the main body has a laser head for producing laser light, the beam splitter is connected with the laser head on the main body, thereby the laser light can be split by the beam splitter, one end of each of the transmitting lines is connected to the beam splitter, while the other end of each is connected to a corresponding one of the scanheads, thereby the laser light split by the beam splitter can be transmitted to each scanhead through each corresponding one of the transmitting lines.

The other objects, features and advantages of the present invention will be apparent after reading the detailed description of the preferred embodiment in reference to the accompanying drawings.

### BRIEF DESCRIPTION OF THE DRAWINGS

FIG. 1 is a schematic view showing the structure of an embodiment of the laser-marking machine of the present invention.

### DETAILED DESCRIPTION OF THE PREFERRED EMBODIMENT

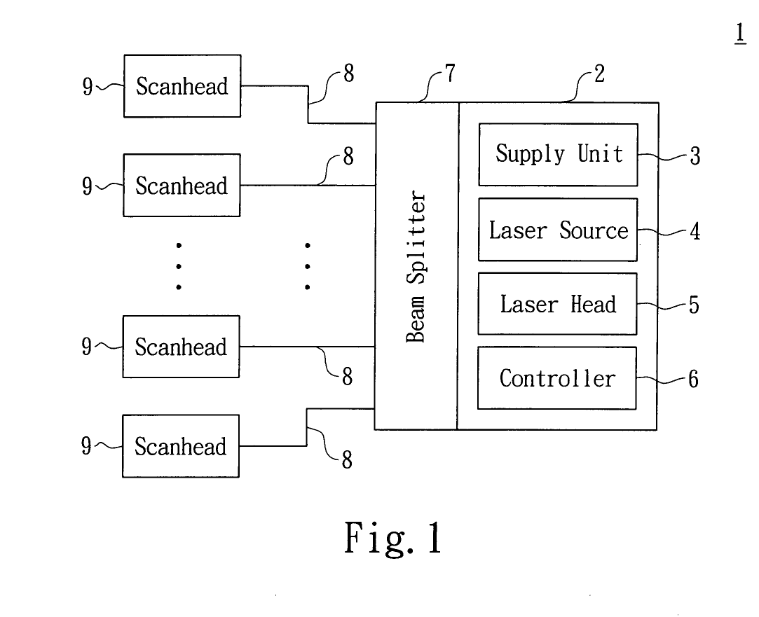

Referring to FIG. 1 showing an embodiment of a laser-marking machine 1 of the present invention, the machine 1 comprises: a main body 2, a beam splitter 7, a plurality of transmitting lines 8 and a plurality of scanheads 9.

The main body 2 has a laser head 5 to output laser light. The main body 2 further has therein a laser source 4 and an electric supply unit 3. The beam splitter 7 is connected with the laser head 5 of the main body 2; thereby laser light can be split by the beam splitter 7. The transmitting lines 8 are optical fibers, one end of each of the transmitting lines 8 is connected to the beam splitter 7, while the other end of each of the transmitting lines 8 is connected to a corresponding one of the scanheads 9, thereby the laser light split by the beam splitter 7 can be transmitted to each scanhead 9 through each corresponding one of the transmitting lines 8.

In operating, referring to FIG. 1, after assembling of the main body 2, the beam splitter 7, the transmitting lines 8 and the scanheads 9, a user can take a laser source 4 with desired watts. After the laser-marking machine 1 is activated, the laser light output from the laser source 4 and laser head 5 in the main body 2 can pass through the beam splitter 7 connected on the laser head 5 and the transmitting lines 8, thus the light path is transmitted to the scanheads 9, so that in use, the laser-marking machine 1 can be used for a plurality of production lines by the design of the plural scanheads 9.

Besides, the main body 2 may include a controller 6 therein in order that each of the scanheads 9 can be controlled by the controller 6 to provide different outputs.

The present invention thereby has the following advantages:
1. The present invention uses a conception of one- for-multiplicity to design a beam splitter to make a laser-marking machine able to afford use of multiple production lines by providing a plurality of scanheads through the beam splitter; this can largely lower the cost of production and increase the efficiency of production.
2. The laser-marking machine according to the present invention has a plurality of scanheads to provide various output to meet various requirements of users; this not only can reduce the working hours for output, but also can increase the capability of the laser-marking machine itself. By such modularized design, the present invention needs only to change a laser source of different watts for each different operation, it is very convenient in use.

The above description of embodiment of the present invention is not for giving any limitation to the scope of the present invention. It will be obvious to those skilled in this art to make partly modifications or changes equivalent to the present invention without departing from the spirit of the invention.

1. A laser-marking machine with multiple scanheads comprising:
a main body having a laser head for producing laser light;
a beam splitter connected with said laser head on said main body, thereby laser light being adapted to splitting by said beam splitter;
a plurality of transmitting lines, one end of each of said transmitting lines being connected to said beam splitter; and
a plurality of scanheads; wherein, the other end of each of said transmitting lines is being connected to a corresponding one of said scanheads, thereby laser light split by said beam splitter is transmitted to each of said scanheads through each corresponding one of said transmitting lines.

2. The laser-marking machine with multiple scanheads as in claim 1, wherein said main body further has a laser source and an electric supply unit therein.

3. The laser-marking machine with multiple scanheads as in claim 1, wherein said transmitting lines are optical fibers.

4. The laser-marking machine with multiple scanheads as in claim 1, wherein said main body further includes therein a controller in order that each of said scanheads is controlled by said controller to provide different outputs.
